(19) United States
(12) Patent Application Publication
(10) Pub. No.: US 2005/0193568 A1
(43) Pub. Date: Sep. 8, 2005

(54) Long-blade cutter with adjustable blade extension and retractable blade guard

(76) Inventors: Jean-Claude Peyrot, Bordeaux (FR); Cedric Chevalier, Angouleme (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/066,901

(22) Filed: Feb. 25, 2005

(30) Foreign Application Priority Data
Mar. 2, 2004 (FR) 04 02131

(51) Int. Cl. B67B 7/00

(52) U.S. Cl. 30/162; 30/2; 30/286

(57) ABSTRACT

The purpose of this invention is a long-blade cutter with adjustable blade extension and retractable blade guard including an elongated body in which the blade can retract, a slider capable of moving the blade in its plane, a blade holder/loader within which the blade can slide, characterized in that it also includes a safety guard made up of an extended element that can cover the edge of the blade over its full length, arranged movable between a fully retracted position inside the body and an extended position over the entire length of the blade at its position of maximum extension, an elastic recall link mechanism interposed between said safety guard and the slider, means of driving the guard by said slider and a push-button for disengaging said means of driving.

### RELATED APPLICATION

The present application claims priority to French Application No. 04 02131 filed Mar. 2, 2004.

### TECHNICAL FIELD

This invention relates to a long-blade cutter with adjustable blade extension, equipped with a retractable blade guard.

### BACKGROUND ART

The purpose of this invention is to propose a cutter with a blade edge which, when the blade is extended, is permanently shrouded along its entire length, irrespective of the depth of extension of the blade out of the body of the cutter, with a device forming a protective cover, the latter disappearing automatically when the cutter is in a cutting mode and returning just as automatically to its protective position when the blade leaves the material being cut.

A safety device in accordance with this purpose but outfitting a fixed-blade cutter is known from document EP 0 963 819, such a device not being suitable for a cutter with an adjustable blade extension.

### SUMMARY OF THE INVENTION

The purpose of this invention is to provide a long-blade cutter with adjustable blade extension and retractable blade guard including:
an elongated body into which the blade can fully retract;
a mounted slider which slides on the body and can move the blade within its plane;
a blade holder/loader located inside the body in which the blade can slide; characterized in that it also includes:
a safety guard made up of an extended element designed to cover the edge of the blade over its entire length, arranged translationally moveable between a fully retracted position in the body and an extended position over the entire length of the blade at its position of maximum extension;
an elastic return link mechanism interposed between said safety guard and the slider;
means of driving the guard by said slider, in the direction of the extension out of the body, said means being disengageable;
and a push-button for disengaging said means of driving.

According to one implementation method, said disengageable means of driving includes a stop connected to the guard and capable of working together with a drive stop integrated with the slider and retractable by the action of said push-button in order to release the guard from the slider.

Such a device makes it possible to extract the blade from the holder for any length in complete safety, since the guard follows the blade by forming a protective cover over the entire length of the edge of the blade and allows the cutting action to occur on the material by combining on the one hand the release of the guard by pressing on the retraction push-button and on the other hand the pressure exerted on the blade in order to cut into said material, said pressure causing in return the pushing back inside the body by the blade's contact with the material as the cutter is driven into the said material.

This driving in which automatically frees the edge of the blade up to the desired length, happens in an elastic manner on account of the return link mechanism located between the slider and the guard, this mechanism automatically returning the guard into its position fully covering the edge of the blade as soon as the blade separates from the material being cut and is freed from the material, either because the cut is finished, or because of a slippage of the knife which leaves the material at an untimely moment.

Other properties and advantages will emerge from the following description of an implementation method of the cutter in accordance with the invention; this description is given solely by way of an illustrative example, and with reference to the attached drawings.

### BRIEF DESCRIPTION OF THE DRAWINGS

FIG. 1 is a lateral elevation view of the cutter in accordance with the invention;

FIG. 2 is a right perspective view of the cutter from FIG. 1;

FIG. 3a is a view in elevation of the slider in accordance with FIG. 1;

FIG. 3b is an elevation view from the opposite side of the slider from FIG. 3a;

FIG. 3c is a right perspective of the slider from FIG. 3a;

FIG. 3d is a perspective back view of the slider;

FIG. 4 is a perspective view of the safety guard of the cutter;

FIG. 5 is a perspective view of the protection's retraction push-button;

FIG. 6 illustrates the cutter with the blade extended, not in cutting action;

FIG. 7 illustrates the cutter in the action of cutting, and

FIG. 8 illustrates the cutter after the cutting action is completed, the blade having been pulled out of the cut material.

### DETAILED DESCRIPTION OF THE DRAWINGS

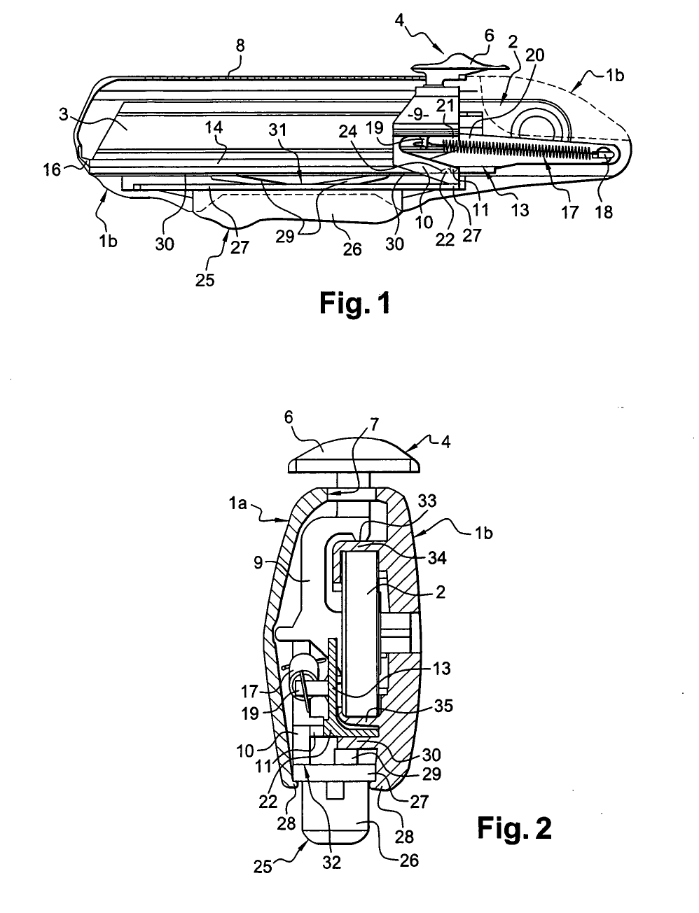

FIGS. 1 and 2 illustrate a cutter in accordance with the invention, with FIG. 1 showing the cutter without its left side, and FIG. 2 showing the cutter also without its back side.

The cutter includes a body for example made of plastic which formed by two connected shells, 1a and 1b respectively (FIG. 2); FIG. 1 shows the cutter with the shell 1a removed.

Inside the body (1a, 1b) is positioned a removable and fixed assembly loader 2, within which slides a long blade 3 connected to a movable slider 4.

It is worth noting that the body could be made of a single shell with a rear-loading system, a snap-out plug mounted at the back of the body having been provided for that purpose.

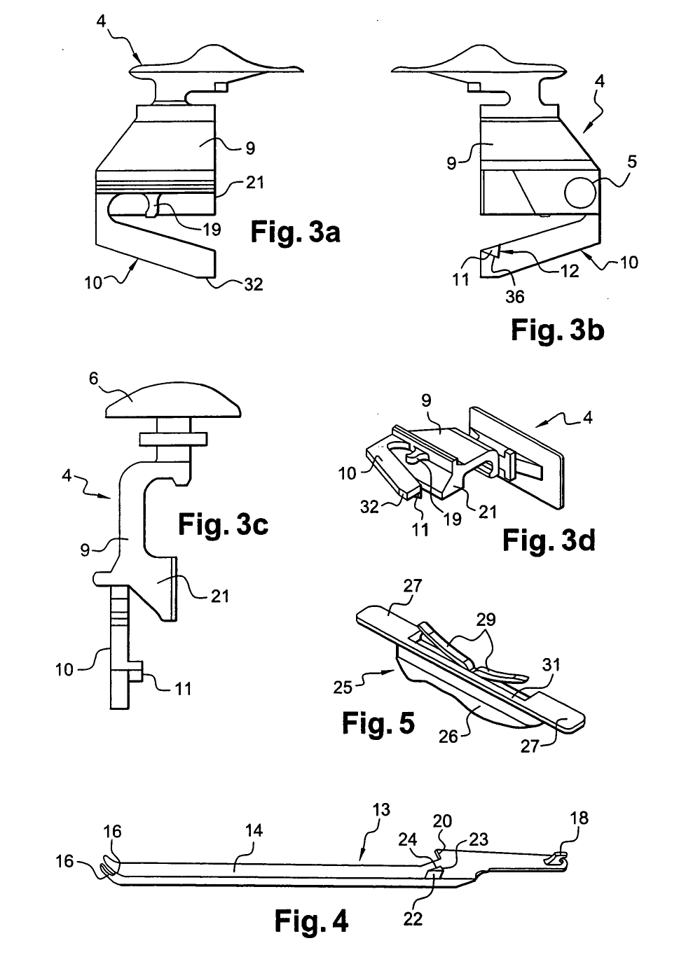

The driving of blade 3 produced by the slider 4 is achieved by means of a circular protrusion 5 (FIG. 3b) positioned laterally to the slider and fitted into a hole provided for according to a known method in the vicinity of the end of the blade.

The slider 4 includes, in the known manner, a section 6 which protrudes out of the body and which can be moved for example using the thumb along a slot 7 positioned longitudinally to the body, on the upper part, said slot 7 having serrated flanks 8 for a step by step displacement of blade 3 over the desired extension length.

The body 9 of the slider 4 extends laterally to the blade 3 and the blade holder 2 and is extended on the lower part by an arm 10 having a certain elasticity, the slider being advantageously manufactured by molding an appropriate plastic material. The arm 10 is directed toward the back of the cutter and bears, at its end, on the inside surface, a triangular drive stop 11 (FIG. 3b) with its drive face 12 turned toward the front of the cutter.

Item 13 represents a safety guard made up of an extended element in the form of a groove 14 (FIG. 4) astride the edge 15 (FIG. 7) and ending with two curved parallel fingers 16 allowing the blade 3 to pass between them.

A return spring 17 attached, on the one hand, to a protrusion 18 at the rear end of the guard 13 and, on the other hand, to a protrusion 19 of the slider 4 is positioned between the guard 13 and the slider 4. Controlled by the spring 17, the guard 13 is stopped with its flange 20 against the rear face 21 of the slider 4.

Laterally, on the lower part and at the level of the arm 10, the guard 13 is equipped with a stop 22 having an active side 23 turned toward the drive stop 11 and in contact with the active side 12 of the latter as shown in FIG. 1.

An inclined slope 24 is made on the protrusion 22 opposite of side 23.

Item 25 illustrates a control push-button for releasing the guard 13.

The push-button 25 is an extended element placed on the lower part of the body (1a, 1b) opposite the slider 4 and extends over a substantial portion of the body roughly in its core. It includes a push section 26 in the strict sense of the word, protruding out of the body and extended internally by a plate 27 whose periphery is pressed (FIG. 2) against the flanges 28 of the body with two elastic tabs 29 braced against an internal ridge 30 integral to one (1b) of the shells of the body.

The ridge 30 further plays a part in the guiding of guard 13.

The plate 27 defines laterally (FIG. 5) a flat straight path 31 for guiding the arm 10 whose end has a surface 32 in contact with said plate 27.

During the movement of the slider 4, its motion is guided by the flanks 8 of slot 7, by plate 27, and by a pad 33 (FIGS. 2 and 3) resting against an internal ridge 34 of shell 1b, said ridge working together with a second ridge 35 to hold the blade holder/loader 2 in place.

The following is the operation of the cutter:

FIG. 1 shows the cutter at rest, with the blade fully retracted, the opposing stops 11 and 22 being in a position of driving the second (22) by the first.

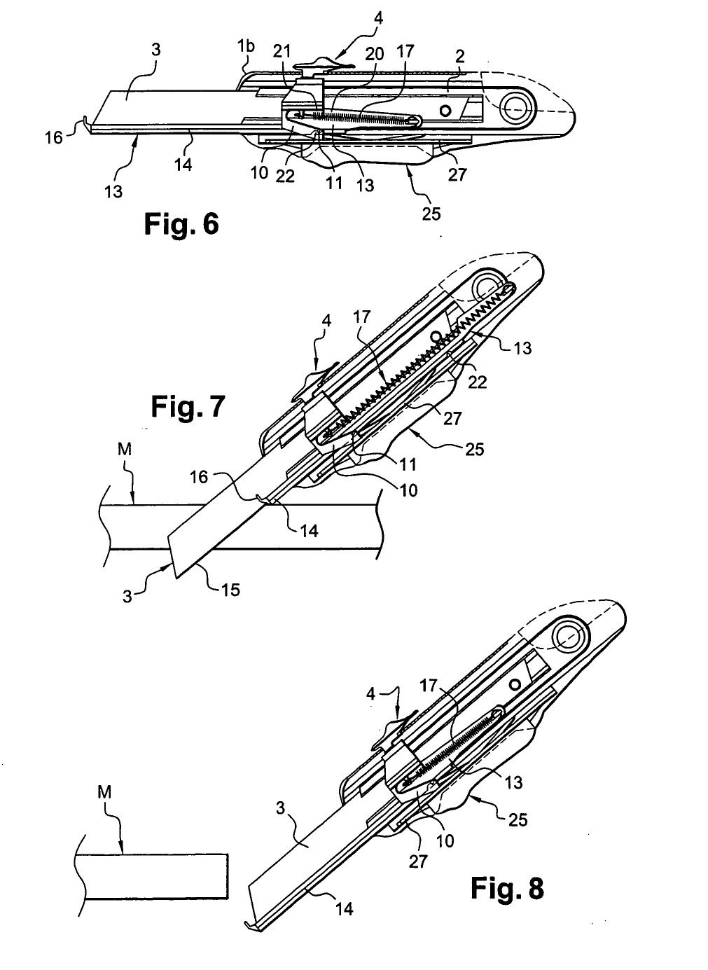

FIG. 6 illustrates the cutter with blade 3 in the position of maximum extension. This is performed by simply moving the slider 4 toward the front of the cutter.

During this motion, the slider, via the stop 11 which pushes the stop 22, carries with it the guard 13 simultaneously with blade 3 whose edge 15 is constantly protected by the groove 14 of the guard as blade 3 is extracted outside of the body.

During the motion of slider 4, the end of the arm 10 slides along the plate (27 and 31) of the button 26.

The blade 3 and the guard 13 are locked, that is to say that the guard 13 cannot be pushed back inside the body if pressure is applied to the end 16 of the guard given that the stop 21 of guard 13 is blocked by stop 11 of slider 4, obviously to the extent that the push-button 25 is not pressed.

If a cutting action is required, for example if a material M such as shown in FIG. 7 must be cut, an inward pressure is exerted on the push-button 25 which causes, the drive stop 11 to be pushed up, via plate 27, because of the elasticity of the arm 10, above the stop 22 of guard 13, thus making it possible for the latter to slide freely in relation to slider 4, under the exclusive return force of spring 17.

Therefore, once the tip of the cutter is pressed against the surface of the material M, the guard 13 may retract and free the blade 3 which then can penetrate the material M and start cutting, the guard 13 penetrating the body in proportion to the penetration of the blade 3 within the material.

It is worth noting that the pressure on the push-button 25 can be released as soon as the guard 13 starts to retract inside the body, the stop 22 of the guard having at that moment moved beyond the stop 11 in the raised position as it encountered no obstacle to being moved inside the body.

The push-button 25 is returned elastically and automatically to the rest position because of the tabs 29 in sliding support on the ridge 30 of the body.

At the end of the cut, as soon as the blade 3 is completed extracted from the material M (FIG. 8), the spring 17 returns the guard 13 to the full covering position of the edge 15 of blade 3.

At the end of the path of guard 13, the stop 22 passes under the stop 11 by lifting it because of the respective corresponding inclined faces 24 of stop 22 and 36 (FIG. 3b) of stop 11.

Thus, the stops 11 and 22 return to their position interlocking the blade 3 and the slider 4 in the direction of extension of the blade.

Therefore, the cutter shown in FIG. 8 is in the same safety position as shown in FIG. 6, obviously on the condition that the push-button 25 is not pressed.

The backwards return of the slider 4 drives the blade 3 inside the body, via the contact areas 21 of the body 9 and 20 of the guard 13, such that the blade returns to its rest position as shown in FIG. 1.

1. A long-blade cutter with an adjustable extension and retractable blade guard, including:
an elongated body into which the blade can fully retract;
a mounted slider which slides on the body and can move the blade within its plane;
a blade holder/loader located inside the body and in which the blade can slide;
a safety guard made up of an extended element designed to cover the edge of the blade over its entire length, arranged translationally moveable between a fully retracted position in the body and an extended position over the entire length of the blade at its position of maximum extension;
an elastic return link mechanism interposed between said safety guard and the slider;
means for driving the guard by said slider in the direction of extension out of the body, with said means for driving the guide capable of being disengaged; and
a push-button for disengaging said means of driving the guide.

2. A cutter in accordance with claim 1, said means for driving the guide including a stop connected to the guard and capable of working together with a drive stop integrated with the slider and retractable by the action of said push-button in order to release the guard from the slider.

3. A cutter in accordance with claim 2, said drive stop of slider being positioned at the end of an elastic arm integrated with the slider, said elastic arm abutably sliding over a plate integrated with said push-button.

4. A cutter in accordance with claim 3, said push-button being equipped with an elastic device for returning said push-button to the rest position.

5. A cutter in accordance with claim 4, the return device comprising two elastic tabs braced and in sliding support against a ridge of the body.
